(19) United States
(12) Patent Application Publication
(10) Pub. No.: US 2013/0007957 A1
(43) Pub. Date: Jan. 10, 2013

(54) MOVABLE LIFT DEVICE INCLUDING OVERTURN PREVENTING SYSTEM

(75) Inventors: Kyeoung Jin Chun, Uiwang (KR); Do Hyung Lim, Hwaseong (KR)

(73) Assignee: KOREA INSTITUTE OF INDUSTRIAL TECHNOLOGY, Cheonan (KR)

(21) Appl. No.: 13/636,689

(22) PCT Filed: Apr. 1, 2011
(86) PCT No.: PCT/KR2011/002263

§ 371 Date: Sep. 23, 2012

(30) Foreign Application Priority Data
Apr. 1, 2010 (KR) 10-2010-0029966

(51) Int. Cl. A61G 7/14

(52) U.S. Cl. 5/87.1; 5/83.1

(57) ABSTRACT

The present invention relates to a movable lift device including an overturn preventing system that uses variation in the center of gravity when rotating a bed unit where a user is laid down to prevent a movable lift device from overturning, which includes a base frame defining a bottom surface; an upper structure comprising a post rotatably upwardly extended from the base frame a predetermined length and a bed unit supported by the post, being horizontal with the bottom surface to enable a user to lie down, wherein the bed unit is rotatably provided with respect to the base frame; and an overturn preventing control unit for controlling the height of the bed unit with respect to the base frame based on the rotation of the bed unit.

### TECHNICAL FIELD

Embodiments of the invention may relate to a movable lift device, more particularly, to a movable lift device including an overturn preventing system that uses variation in the center of gravity when rotating a bed unit where a user is laid down to prevent a movable lift device from overturning.

### BACKGROUND

Generally, the patient or the elderly who is not able to move about freely may need help of care workers or family dependents. In a long distance trip or moving, a wheelchair or a movable bed can be used for a patient who needs an intensive-care with an advanced disease or an elderly man who has difficulty in getting around for oneself.

However, it is extremely inconvenient to move the patient from such a movable bed and it is not even easy for a care worker to move the patient from a sickbed to such a movable bed. Accidents of back injury frequently happen to carers because of the elderly man's or patient's weight. Accordingly, there have been under development various lift devices for helping the sick or elderly to be moved or lifted in recent.

However, a conventional movable lift device performs a simple function of lifting or taking down a patient or a function of moving a patient lying thereon. Such a conventional movable lift device has many limitations on a passage of the movement. There might still be a possibility of accidents which happen when a care worker or family dependent cares for a patient, even with the conventional movable lift device.

In other words, such a bed is formed with a predetermined longitudinal length along one direction to lay a patient thereon. An entire portion of such the movable lift device has to be rotated to pass a passenger, who encounters in the corridor, or a narrow door. Because of that, there is a disadvantage of inconvenience that might happen to the carer moving the movable lift device and the patient lied on the movable lift device.

### DISCLOSURE

### Technical Problem

To solve the problems, an object of the present invention is to provide a movable lift device including a rotatable bed that can be rotated alone for movement convenience.

Another object of the present invention is to provide a movable lift device including a rotatable bed, with a stable structure of preventing the movable bed from overturning even when the center of mass of the movable lift device is changed by the rotation of the bed.

A further object of the present invention is to provide a movable lift device including a rotatable bed, which can selectively restrict or allow rotation of a bed to have an enhanced safety for a patient lying thereon and a carer.

### Technical Solution

To achieve these objects and other advantages and in accordance with the purpose of the embodiments, as embodied and broadly described herein, a movable lift device having an overturn preventing system includes a base frame defining a bottom surface; an upper structure comprising a post rotatably upwardly extended from the base frame a predetermined length and a bed unit supported by the post, with being horizontal with the bottom surface to enable a user to lie down, wherein the bed unit is rotatably provided with respect to the base frame; and an overturn preventing control unit controlling the height of the bed unit with respect to the base frame based on the rotation of the bed unit.

The upper structure may include a post rotatably coupled to the base frame; a boom movably provided along the post; and a bed unit connected to the bottom.

The overturn preventing control unit may include a height adjusting part upwardly moving the boom with respect to the post, to control the height of the boom with respect to the base frame based on a rotational angle of the bed unit.

The height adjusting part may include an ascending ball formed in the post along a longitudinal direction of the post, with a screw thread formed in an inner circumferential surface of the ascending ball; a screw provided in the boom along a longitudinal direction of the ascending ball, with a screw thread formed in an outer circumferential surface, to engage with the screw thread of the ascending ball; and a height adjusting motor rotating the screw in a forward and reverse direction based on the control of the overturn preventing control unit to upwardly move the boom engaging with the post.

The movable lift device comprising the overturn preventing system may further include one or more extending leg selectively extendible toward an outside of the base frame to movably support the base frame with respect to the bottom surface, wherein the overturn preventing control unit controls the extension of the extending leg based on the rotation of the bed unit.

The overturn preventing control unit may include an extension driving part extending the extending leg with respect to the base, and the overturn preventing control unit may control the extension of the extending leg based on a rotational angle of the bed unit.

The extension driving part may include a rack extended toward the base frame from the extending leg, with a gear tooth formed in a surface thereof; and a extension adjusting motor fixed to the base frame, engaging with the rack, the extension adjusting motor rotated in a forward or reverse direction a predetermined number of times to move the rack linearly.

### Advantageous Effects

The movable lift device including the rotatable bed according to the embodiments has following advantageous effects.

First, the post supporting the bed is rotatably provided and only the bed may be rotated even without rotating the base frame overall. Accordingly, the movable lift device including the rotatable bed may be advantageous when passing a narrow corridor or door.

Second, the extending leg is extended by the overturn preventing control unit as the bed unit is rotated, to stably support the moment generated by the bed unit rotated by the extended extending leg or to lower the height of the bed unit. Accordingly, the movable lift device may prevent the movable lift device from overturning and there may be an effect of preventing the patient's secondary wounded.

### BRIEF DESCRIPTION OF THE DRAWINGS

FIG. 1 is a perspective view illustrating a movable lift device including a rotatable bed according to one embodiment of the present invention;

FIG. 2 is a side view of FIG. 1;

FIG. 3 is a perspective view illustrating the bed shown in FIG. 1 in a state of contacting with the ground after descending;

FIG. 4 is a perspective view illustrating the rotatable bed shown in FIG. 3 in a state of being separated;

FIG. 5 is a perspective view illustrating the bed unit shown in FIG. 1, with an adjusted angle'

FIG. 6 is a perspective view illustrating an extending leg extended by the rotated bed unit of the movable lift device;

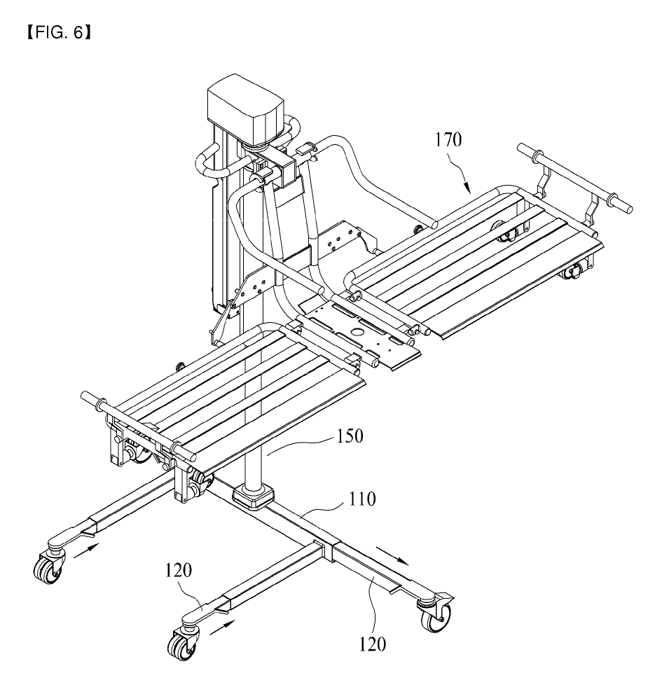

FIG. 7 is a sectional view illustrating one embodiment of a height adjusting part provided in the movable lift device shown in FIG. 1;

FIG. 8 is a perspective view illustrating the bed unit rotated to have the height thereof decreased in the movable lift device shown in FIG. 1; and

FIG. 9 is a side view of FIG. 8.

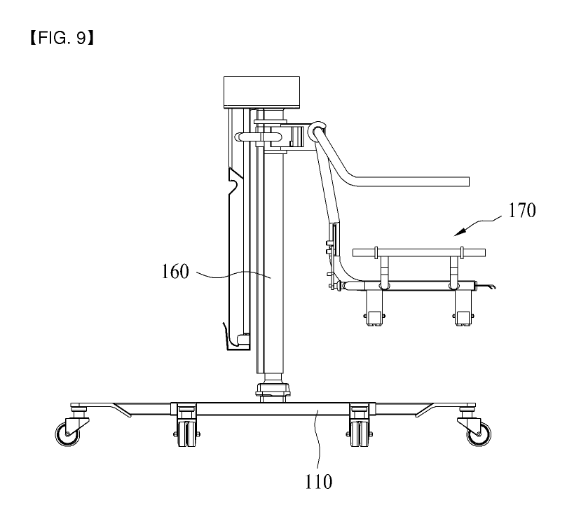

### BEST MODE

Embodiments of the present invention will be described in detail in reference to the accompanying drawings and contents disclosed in the drawings and the present invention is not limited to the embodiments. Reference may now be made in detail to specific embodiments, examples of which may be illustrated in the accompanying drawings. Wherever possible, same reference numbers may be used throughout the drawings to refer to the same or like parts.

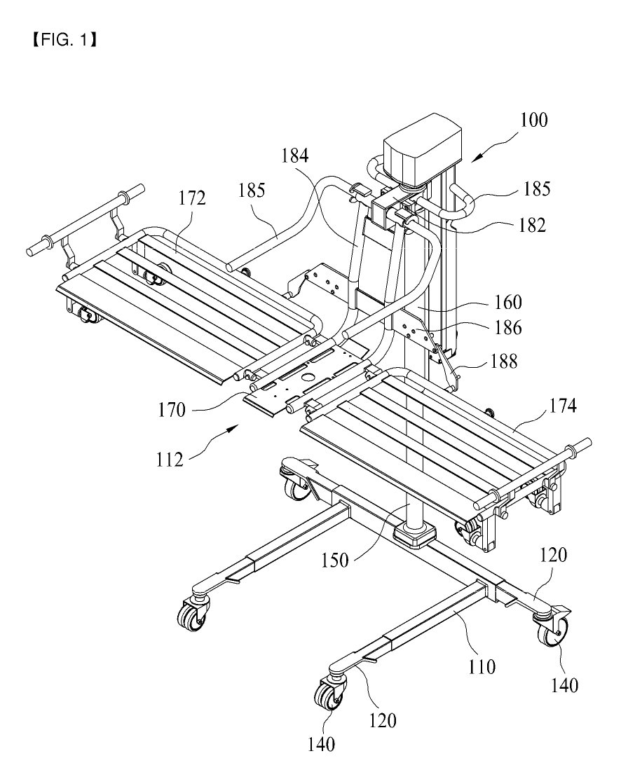

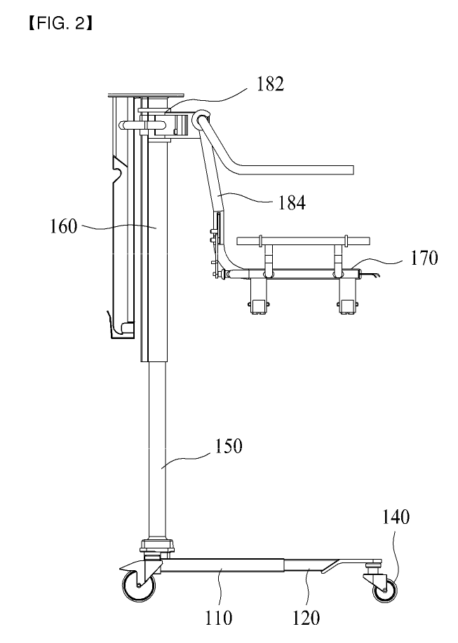

As shown in FIGS. 1 and 2, a movable lift device 100 having an overturn preventing system according to one embodiment of the present invention (hereinafter, a movable lift device') includes a base frame 110, an upper structure 112 and an overturn preventing control unit.

The base frame 110 defines a bottom surface of the movable lift device 100 according to this embodiment and it supports the other components provided in the movable lift device 100 with respect to the defined bottom surface.

As shown in FIG. 1, such the base frame 110 may be formed in a framed structure or a panel structure with a predetermined area.

A plurality of extending legs 120 may be provided in an outer circumference of the base frame 110.

Each of the extending legs 120 may be extended from the base frame 110 outwardly and extendible via an extension driving part selectively which will be described later.

A roller 140 is provided in an end of each extending leg 120 to movably support the extending leg 120 and the base frame 110 with respect to the bottom surface.

The upper structure 112 is mounted to an upper portion of the base frame 110.

The upper structure 112 may include a post 150 and a bed unit 170.

The post 150 supports the bed unit 170 that is spaced apart a predetermined distance from the ground, which will be described in detail later, and it enables the bed unit 170 to ascend. Such the post 140 may be longitudinally formed to vertically support the bed unit 170 spaced apart from the base frame 110.

The bed unit 170 is formed to lay an elderly man or a patient thereon and it is ascendable along the post 140, with an adjustable height.

The bed unit 170 includes a plurality of wheels provided in a lower portion thereof to move easily when it descends on the ground.

The bed unit 170 is ascendable along the post 150. For that, a boom 160 may be provided between the post 150 and the bed unit 170.

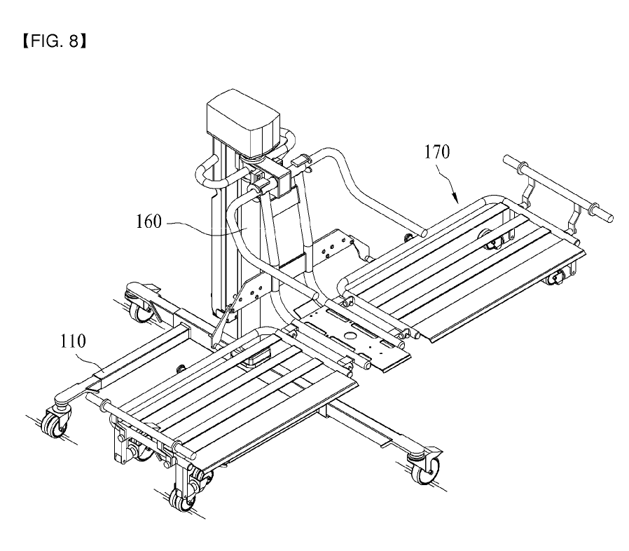

As shown in FIGS. 1 and 8, the boom 160 is mounted to move along the post 150 according to the height adjusting part which will be described later. The bed unit 170 is coupled to a predetermined portion of the boom 160.

Meanwhile, the bed unit 170 is supportedly coupled to the boom 160 via a detachable part 182, a first arm 184 and a second arm 186.

The detachable part 182 may be detachably coupled to the boom 160.

The first arm 184 is extended from the detachable part 182 along a predetermined direction and the bed unit 170 is fixed to the first arm 184. According to this embodiment, the first arm 184 is extended perpendicularly with respect to the ground and the bed unit 170 is coupled to both perpendicularly extended ends of the first arm 184 as shown in FIGS. 1 and 2. The bed unit 170 may be divided into a plurality of parts that consist of a first bed part 172 and a second bed part 174. In this instance, a pair of first arms 184 may be provided and the first and second bed parts 172 and 174 may be rotatably connected to the pair of the first arms 184 by a hinge.

The second arm 186 may be coupled to the bed unit 170 in parallel with respect to the first arm 184. Links 188 capable of adjusting a rotational angle may be provided in both ends of the second arm 186, respectively. An end of each link 188 may be rotatably coupled to a predetermined point spaced apart a predetermined distance from the position where the bed unit 17 is rotatably coupled to the first arm 184. The angles of the first and second bed parts 172 and 174 may be adjustable.

Also, a first handle 183 is provided in the bed unit 170 to be held by the elderly man or patient trying to lie down on the bed unit 170 or to get out of the bed unit 170. The first handle 183 may be held to pull or push the bed unit 170 when the bed unit 170 is placed on the ground. The first handle 183 may be rotatably provided to be tilted back if necessary, such that it may not interfere with the elderly man or patient's lying on the bed unit or getting out of the bed unit.

Moreover, a second handle 185 may be provided in the boom 160 or the post 150 to be used in pushing or pulling the movable lift device 100 by the protector or carer.

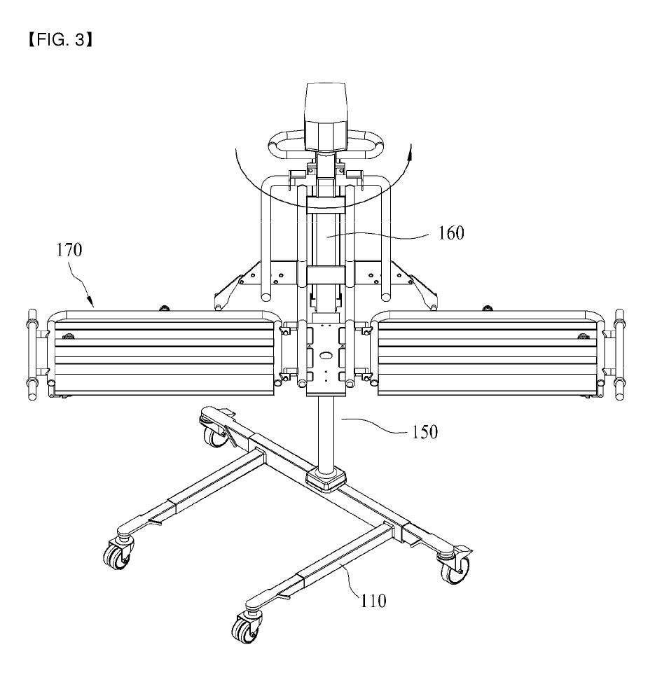

Meanwhile, as shown in FIG. 3, the bed unit 170 is rotatably horizontal with respect to the base frame 110. For that, a lower end of the post 150 is rotatably coupled to the base frame 110 in this embodiment.

By nonlimiting example, such the boom having the bed unit coupled thereto or the detachable part coupled to the boom may be rotatable.

Accordingly, the post 150 is rotatable and both of the boom 160 and the bed unit 170 provided in the post 150 may be rotated together with the rotation of the post 150. Even when the movable lift device 100 moving along the corridor encounters a person in opposite or turns around the corner of the narrow corridor or pass through a narrow door, it is unnecessary to rotate the entire portion of the movable lift device 100 and only the post 150 is rotated to rotate the bed unit 170. Accordingly, the bed unit 170 can be rotated at an optimal angle more efficiently and protector or carer convenience can be enhanced.

However, the first arm 184 is extended along a downward direction or in a horizontal direction. The bed unit 170 is coupled to the horizontally extended portion of the first arm 184. As shown in FIG. 2, the bed unit 170 may be supported at a position spaced apart a predetermined distance from the post 150.

However, the bed unit 170 is supported at the position spaced apart a predetermined distance from the post 150 in a horizontal direction. Accordingly, as the post 150 is rotated, the bed unit 170 is also rotated and the center of gravity can change. In this instance, the weight of the person lying on the bed unit 170 is added to the base frame 110 and a moment according to the distance with the supporting position of the base frame 110 is applied to the base frame 110, such that the movable lift device 100 might overturn. Also, when the surface of the floor is inclined in a state where the center of gravity is concentrated by the rotated bed unit 170, the possibility of the overturn might be heightened. When the user is lying on the bed unit 170, the overturn of the movable lift device 100 is likely to cause a fatal injury, considering that the user is a senior or patient.

Accordingly, to reduce the possibility of the movable lift device 100 overturning, an overturn preventing control unit is further provided in the movable lift device.

The overturn preventing control unit may control the extension of the extending leg 120 based on the rotation of the bed unit 170 by the extension driving part.

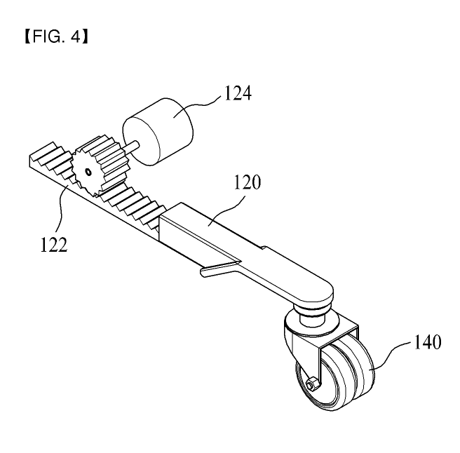

The extension driving part may include a rack 122 and an extension adjusting motor 124 as shown in FIG. 4.

The rack 122 is extended from the extending leg 120 toward the base frame 110 and a gear tooth is formed in a surface.

The extension adjusting motor 124 is fixed to the base frame 110 and it engages with the gear tooth to rotate in the forward and reverse direction. Accordingly, the extension adjusting motor 124 moves the rack 122 and the extending leg 120 having the rack 122 formed therein in a longitudinal direction of the rack 122.

In other words, as the extension adjusting motor 124 rotates in the forward direction, the rack 122 and the extending leg 120 are pushed and extended outer to the base frame 110. As the extension adjusting motor 124 rotates in the revere direction, the rack 122 and the extending leg 120 are pulled and contracting toward the inside of the base frame 110.

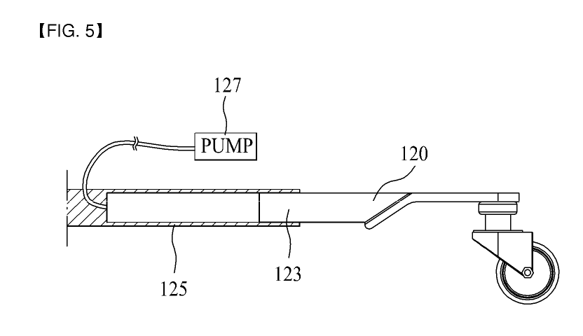

Meanwhile, as shown in FIG. 5, the extending leg 120 may include a piston 123 extended toward the base frame 110, a cylinder 125 formed to surround the piston 123 and an air pump 127 formed to control an air pressure inside the cylinder 125.

In other words, when the air pressure inside the cylinder 125 is increased by the air pump 127, the piston 123 is pushed and the extending leg 120 is pushed and extended. When the air pressure inside the cylinder 125 is decreased by the air pump 127, the piston 123 is pulled to contract toward the inside of the base frame 110.

When the center of gravity is varied by the rotated bed unit 170, the overturn preventing control unit drives the extension adjusting motor 124 or the air pump 127 provided in the extending leg 120 toward the direction of the center of gravity of the bed unit 170, to extend the extending leg 120. At this time, one extending leg 120 not toward the center of gravity is controlled to contract and the space occupied by the base frame 110 can be reduced.

The extending leg 120 may contract according to the rotation of the bed unit 170. Accordingly, the supporting point supporting the bed unit 170 and the post 150 may be broadened to support the bed unit 170 and the post 150 stably.

Meanwhile, the overturn preventing control unit may be configured to control the height adjusting part to adjust the height of the bed unit 170 based on the rotation of the bed unit 170.

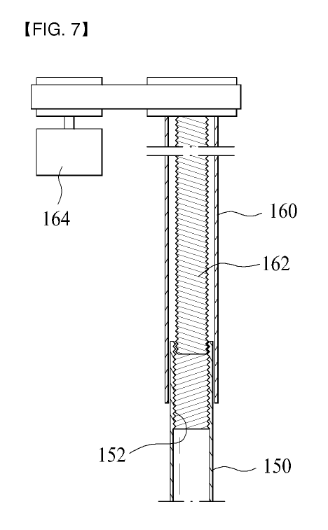

FIG. 7 is a sectional view illustrating the height adjusting part.

The height adjusting part is configured to move the boom 160 with respect to the post 150 upwardly. The height adjusting part may include an ascending ball 152, a screw 162 and a height adjusting motor 164.

In other words, the ascending ball 152 having a screw thread formed in an inner circumferential surface thereof along a longitudinal direction of the post 150 may be formed in the post 150. The screw 162 having a screw thread formed in an outer circumferential surface thereof along a longitudinal direction of the ascending ball 152 and the height adjusting motor 164 configured to rotate the screw 162 in the forward and reserve direction may be provided in the boom 160. The screw 162 engages with an inner circumferential surface of the ascending ball 152 and it is rotated in the forward and reverse direction by the height adjusting motor 164, to move upwardly or downwardly along the ascending ball 152 to move upwardly or downwardly the bed unit 170 connected to the boom 160.

Accordingly, when the center of gravity is varied by the rotated bed unit 170, the overturn preventing control unit rotates the height adjusting motor 164 to control the height of the bed unit 170.

In other words, the bed unit 170 is rotated and the center of gravity is varied. After that, the height of the bed unit 170 is lowered and the distance between the center of gravity of the bed unit 170 and the base frame 110 is reduced, only to reduce the moment. Accordingly, the movable lift device 100 is prevented from overturning.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A movable lift device comprising an overturn preventing system comprising:
a base frame defining a bottom surface;
an upper structure comprising a post rotatably upwardly extended from the base frame a predetermined length and a bed unit supported by the post, being horizontal with the bottom surface to enable a user to lie down, wherein the bed unit is rotatably provided with respect to the base frame; and
an overturn preventing control unit for controlling the height of the bed unit with respect to the base frame based on the rotation of the bed unit.

2. The movable lift device comprising the overturn preventing system according to claim 1, wherein the upper structure comprises,
a post rotatably coupled to the base frame;
a boom movably provided along the post; and
a bed unit connected to the bottom.

3. The movable lift device comprising the overturn preventing system according to claim 2, wherein the overturn preventing control unit comprises a height adjusting part upwardly moving the boom with respect to the post, to control the height of the boom with respect to the base frame based on a rotational angle of the bed unit.

4. The movable lift device comprising the overturn preventing system according to claim 3, wherein the height adjusting part comprises,
an ascending ball formed in the post along a longitudinal direction of the post, with a screw thread formed in an inner circumferential surface of the ascending ball;
a screw provided in the boom along a longitudinal direction of the ascending ball, with a screw thread formed in an outer circumferential surface, to engage with the screw thread of the ascending ball; and
a height adjusting motor rotating the screw in a forward and reverse direction based on the control of the overturn preventing control unit to upwardly move the boom engaging with the post.

5. The movable lift device comprising the overturn preventing system according to claim 1, further comprising:
one or more extending leg selectively extendible toward an outside of the base frame to movably support the base frame with respect to the bottom surface,
wherein the overturn preventing control unit controls the extension of the extending leg based on the rotation of the bed unit.

6. The movable lift device comprising the overturn preventing system according to claim 5, wherein the overturn preventing control unit comprises,
an extension driving part extending the extending leg with respect to the base,
wherein the overturn preventing control unit controls the extension of the extending leg based on a rotational angle of the bed unit.

7. The movable lift device comprising the overturn preventing system according to claim 6, wherein the extension driving part comprises,
a rack extended toward the base frame from the extending leg, with a gear tooth formed in a surface thereof; and
an extension adjusting motor fixed to the base frame, engaging with the rack, the extension adjusting motor rotated in a forward or reverse direction a predetermined number of times to move the rack linearly.
